(19) United States
(12) Patent Application Publication
(10) Pub. No.: US 2005/0114233 A1
(43) Pub. Date: May 26, 2005

(54) Inventory on-line method for the internet

(76) Inventor: Harry Mays, Merced, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/718,977

(22) Filed: Nov. 20, 2003

(51) Int. Cl. G06F 17/60

(52) U.S. Cl. 705/28

(57) ABSTRACT

An inventory online (IOL) method and system provides the control and data for a virtually supplemented inventory for the maintenance inventory holder (MIH) reducing the required on site inventory size and, consequently, the inventory cost. The MIH is provided with an Inventory Online (IOL) through inventory control software over the Internet. This will in effect replace a portion of the normally required In-house Inventory (IHI) with inventories held by specific vendors (VI), inventories held by the general market (GMI) or shared inventories held in common with other MIHs (SI). The system provides control pages for inventory listing, inventory costing, shared inventory, online offer for sale of excess inventory, search and message capability, and a system wide item search utilizing the UPC code.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

This invention relates to an inventory online system and processes and more particularly provides participating online manufacturer, vendor, and supplier participation in a virtual online inventory for maintenance inventory holders with mutual advantage to all participants.

### BACKGROUND OF THE INVENTION

Large amounts of money are invested in replacement part inventories for plant equipment by manufacturers through their plant maintenance departments. In the following application, a manufacturer holding such an inventory will be referred to as a Maintenance Inventory Holder (MIH).

In addition to the purchase cost of any item included in the inventory is added its maintenance cost which is estimated at 15% of its purchase annually excluding opportunity loss of capital. Proper control is important. Non essential items should not be kept in inventory. At the same time critical items must be available when needed.

The means used to control these maintenance inventories vary widely from virtually no program at all to manual or computerized programs of varying accuracy or, lastly, to the very sophisticated software programs used by some large manufacturing companies. Recently, some of these high-end inventory control software programs have been offered for lease over the Internet by what are called Application Service Providers (ASPs).

To aid in product identification some control programs use identification codes for inventoried items that are frequently bar coded on the item itself. These codes are often developed just for the user and have no relation to any other identification code.

There is a code, however, developed and administered by the Uniform Code Council of the USA and the European Article Number organization, in cooperation, that has universal recognition. Manufacturers using this code are assigned an 8-digit identification number. This number is then used in the first part of a 14-digit product code number. This code number identifies any product from this manufacturer exactly. Since being introduced to industry just five years ago the code has gained widespread use. Many manufacturers are bar coding their UPC code numbers on product packages. All evidence indicates that this system will become the worldwide standard for product identification.

The MIH, of course, has control over his own inventory of these repair and replacement components for production equipment. There is a significant investment in these maintenance inventories. Interviews with some local manufacturing plants show more than $5MM in maintenance inventory value in just three mid-sized plants. Taking into account there are over 360,000 manufacturing facilities in the U.S. and probably that number and more in Mexico, Canada and Europe, the size of this investment can be appreciated. The annual purchases of manufacturing components in the U.S., much of which goes into this inventory, are in the tens of billions of dollars.

Most items for this inventory are purchased from industrial supply houses located across the country that either inventory or can acquire products from the various manufacturers of industrial maintenance parts. The Industrial Distributors Association (IDA) states there are 13,787 distributor locations in the US selling $32 billion of industrial supplies annually. IDA also states that 76% are privately owned individual houses or small chains. A few are very large though with many branch operations. Purchases not made through these houses are normally made directly from the manufacturer.

The factors considered in a manufacturing plant's determination to inventory any specific item are the likelihood of its requirement, its cost and the effect on production if not readily available either from inventory or directly from outside sources. The cost of this inventory includes both its purchase and its maintenance which consists of the opportunity loss of capital, the space consumed for storage, administration and such things as obsolescence, loss, theft, spoilage and damage. It is estimated the annual cost of maintaining inventory is in the range of 15% of the investment excluding opportunity loss of capital. Often inventory is kept for years without being used or is never used because the equipment never needed that particular part or the equipment it was kept for was replaced. There are also times when a part urgently needed is not in inventory. Proper control of this inventory is important.

The means used to control these inventories vary widely. Some plants have no system at all and just use one person's judgment on what needs to be stocked. Some have systems that change as personnel changes. Some have manual or computerized systems of varying accuracy and sophistication that provide information on the status of the inventory and history of part replacement. The most sophisticated control systems use software that provides data on unit cost, last use, annual use, where the item is stored, where the item is used, total inventory value, scheduled part replacement, and so forth. This last program is most often a comprehensive Enterprise Asset Management (EAM) system designed to control the assets of the entire facility. The software for this program may also provide features such as work order generation, preventive maintenance scheduling, contract management, and other controls. Very recently, just since 2000, Application Service Providers (ASPs) started offering (EAM) software programs for lease over the Internet.

Some plants using inventory control software also use product codes that allow bar coding of their inventory for reliable part identification and rapid data entry. Some local companies interviewed are using, or intend to use, a product code of their own devising for product identification. These codes are for company use only and have no meaning outside the company. There is, however, an existing code already set up for most products that is universally recognized.

Within the last five years there has been introduced a code system of numbers for industrial products introduced by the Uniform Code Council (UCC) of the USA and the European Article Number (EAN) organization, in cooperation, to identify manufactured industrial items. These Universal Product Codes (UPCs) and EAN numbers are now being bar coded on products from most major manufacturers in the US and Europe This system provides a standard ID code that identifies any trade item worldwide. This is the identical system that is used in grocery stores. All the bar-coded items crossing the readers there use the UPC.

To accommodate greater demand, the UPC is being expanded to a 14-digit number to be called the Global Trade Item Number (GTIN) which is being phased in now and will be the worldwide standard starting in January 2005. To explain it simply but not quite accurately, each participating manufacturer is assigned an 8-digit identification number by the UCC or EAN organization. The company ID number occurs in the first part of the UPC. The five numbers following it are then used by that company to identify each of their specific products. The last number is a check digit derived from a mathematical formula using the numbers within the UPC to make sure the number entered does not have transposed or incorrect numbers within it. There is no central databank of UPC numbers with product identification. This information is kept by the individual manufacturer and those he chooses to share it with, which is basically anybody that asks.

Increasingly, major manufacturers and other institutions are using the UCC.EAN system to identify their products for inventory and e-commerce purposes. Several instances are offered in evidence of this increasing use. Before 1997 UCC dealt only with the grocery and public warehousing industries and just started working with the Industrial/Commercial sector, one of six sectors defined by the UCC, late in 1997. Membership in the Industrial/Commercial sector has grown from that beginning in 1997 to a present membership of 35,000. There are in total 1.5 million UCC.EAN members in all six sectors. The U.S. Defense Department has created links so the National Stock Number and the UPC are interchangeable. RosettaNet, a large consortium of electronic businesses, has joined UCC and adopted their standards. Its 450 member companies represent over $1 trillion in annual revenues. Of significance to the subject addressed here is that the Power Transmission Distributors Association (PTDA), a distributor's association affiliated with the IDA, has developed and just approved a standard system for Internet E-commerce. This calls for the distributor to use the UPC, the vendor's own code or the manufacturer's number for product identification. Any PTDA member using the UPC would have a mixed system since not all products have a UPC. However, the PTDA still recommends the UPC as the preferred method for product identification. Of the 29 prime suppliers to Motion Industries, the largest PTDA member, at least 18 use the UPC. These are very large companies with many high end products. It is apparent the UPC will soon be used by all companies wishing to trade over the Internet.

Discovery of Problems

Most plants have unnecessarily high costs for maintenance inventory coverage. There are several reasons for this.

First, most Maintenance Inventory Holders (MIHs) do not have good control over their inventory. They do not use computerized inventory control nor bar coded part ID. This is usually because of the expense and the investment in time and money to investigate options, buy software and set up a bar coding system. Consequently the accounting of their inventory is suspect, not easily updated and the inventory itself, most likely, contains items it should not and does not contain items it should.

Second, many parts are kept in inventories that are readily available from outside sources. These parts are kept in plant inventories because the MIH has no means to be assured of their ready availability.

Third, MIHs have no easy way to find part cost and availability from all potential suppliers.

Fourth, often replacement parts that should be kept in stock are not because of their cost. The urgent need for that part is later discovered along with the resulting cost in lost production.

Fifth, there is no good way to sell dormant or excess inventory. Many plants have not even identified their dormant inventory. The developments discussed in the previous sections provide a means for a solution to these problems.

The reader will understand that the discovery of problems to be solved as well as the solution to those problems can constitute invention. In so far as the problems set forth have not been collectively considered before, invention is claimed.

### BRIEF SUMMARY OF THE INVENTION

An inventory online (IOL) method and system provides the control and data for a virtually supplemented inventory for the maintenance inventory holder (MIH) reducing the required on site inventory size and, consequently, the inventory cost. The MIH is provided with an Inventory Online (IOL) through inventory control software over the Internet. This will in effect replace a portion of the normally required In-house Inventory (IHI) with inventories held by specific vendors (VI), inventories held by the general market (GMI) or shared inventories held in common with other MIHs (SI). The system provides control pages for inventory listing, inventory costing, shared inventory, online offer for sale of excess inventory, search and message capability, and a system wide item search utilizing the UPC code.

Advantages

An advantage is the utilization of the supplier's databases that are incorporated into the system. Access to these databases permits MIHs to search for a source of a part nationally from all participating vendors' inventories. This access would also permit MIHs to electronically monitor any particular vendor's inventory of any specific part or the whole market's inventory of the specific part. This eliminates the need to stock any part that is shown to be dependably and regularly available from outside sources.

A further advantage is that the system enables participation in a common shared inventory with other MIHs for parts not reliably available in the market. This is significantly less costly than carrying any part independently. The use of the system permits posting items of excess or dormant inventory for sale.

Finally, use of the system enables MIHs to send and receive targeted messages from a manufacturer or supplier about a specific product in their inventory.

Finally, the inventory control software can be maintained and upgraded by an application service provider (ASP) for both UPC and non-UPC coded parts.

### BRIEF DESCRIPTION OF THE DRAWINGS

FIG. 1 is a schematic illustrating a section of the western United States with a manufacturer having a maintenance inventory with surrounding inventory sources including general market inventory, manufacturers having shared inventory, and vendors having inventory all contributing to the virtual maintenance inventory of this invention;

FIG. 2 is a screen select portion of a software program including the screen categories of Inventory Listing, Inventory Costing, Shared Inventory, Inventory Selling, Search and Messages, and UPC Search;

FIG. 3 is a sample Inventory Listing in accordance with this invention including UPC code, description, vendor ID, source, and prescribed inventory levels for items in the virtual inventory;

FIG. 4 is a sample Inventory Costing including, among other things, price for each unit, total investment, and annual maintenance charge;

FIG. 5 is a sample Shared Inventory including itemized inventory items with identification of party holding inventory;

FIG. 6 is a sample Inventory Selling for liquidating unwanted maintenance inventory items;

FIG. 7 is a sample Search and Messages section of the disclose software for communicating between inventory participants;

FIG. 8 is a sample Help menu; and,

FIG. 9 is a sample of the result of a search utilizing the UPC code for locating an item in the virtual inventory.

### DETAILED DESCRIPTION OF THE INVENTION

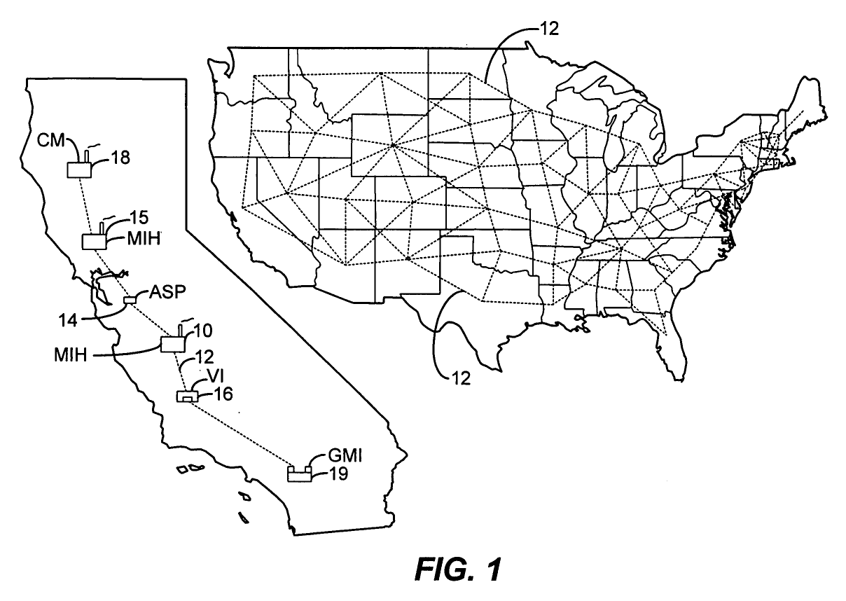

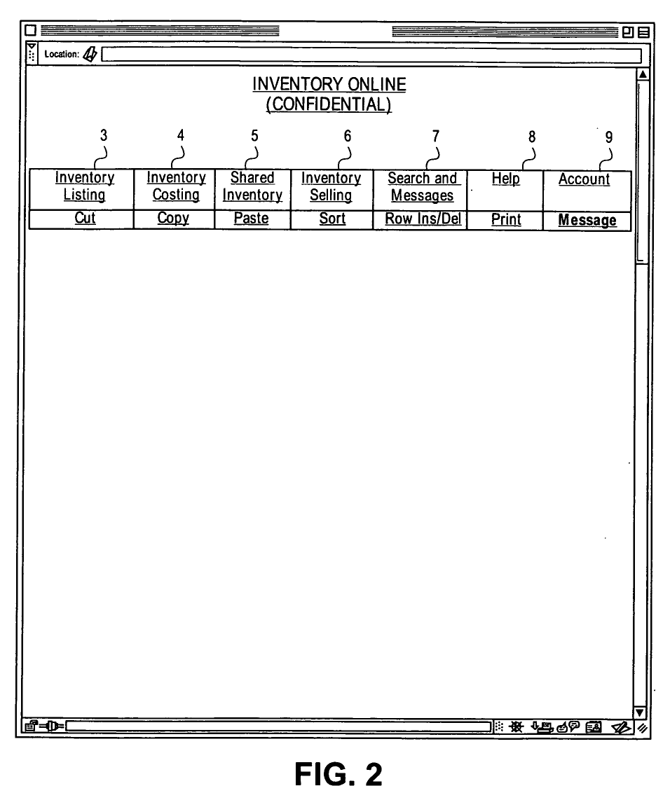

Referring to FIG. 1, illustration of the basic technologies and standards now extant to provide the system and process of this invention to improve control of most inventories, reduce the required size of the inventory and offer other cost savings as well. In FIG. 1, a section of the western United States is illustrated. A manufacturer 10, here located in Bakersfield Calif., is shown schematically connected to the Internet 12. An application service provider 14 (ASP) provides software (see FIGS. 2 through 9) for an Inventory On Line (IOL) to virtually supplement an in-house inventory (IHI) to provide a virtual maintenance inventory for manufacturer 10. The system provides simple, basic inventory control software linked over the Internet with the databases of vendors 16 and component manufacturers 18, using the UPC for part identification for those parts having a UPC. The system also provides for inventories to be shared with other MIHs. A nationwide market for UPC coded maintenance parts over the Internet is provided to the participating MIH. There results a vastly reduced IHI virtually supplemented from the vendors 16, component manufacturers 18, and other participating MIHs 15.

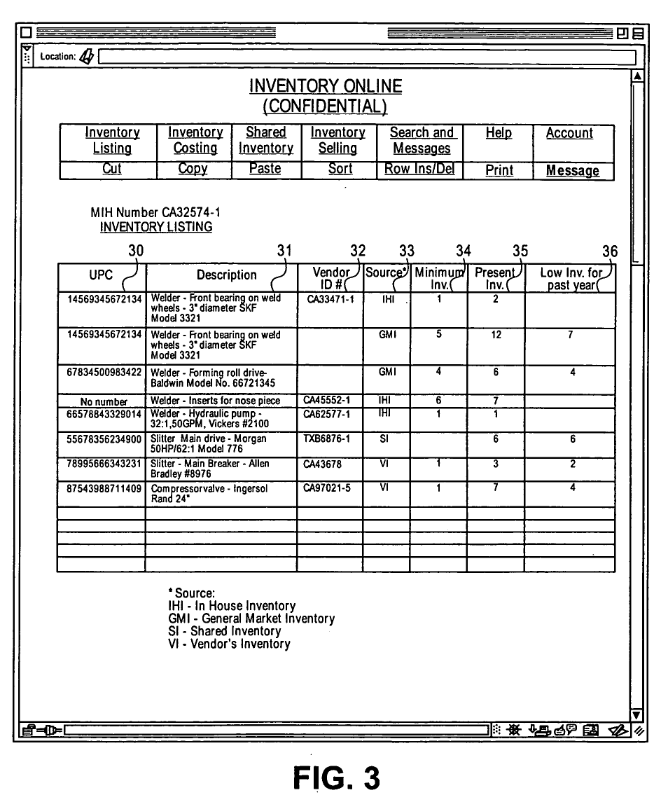

Referring to FIGS. 2 and 3, the proposed ASP software allows an MIH to control inventory accurately and efficiently using modern software. For example, this software provides a simple basic control program accessed over the Internet and easily used by non-technical personnel.

Referring to FIG. 2, a software menu is provided. Have a mouse scroll and then click on a program menu will activate that particular portion of the program. For example, by clicking on “Inventory Listing,” in FIG. 2, the Inventory Listing of FIG. 3 is activated. FIG. 2 is an active portion of all screens illustrated in FIGS. 3 through 9. Conventional “clicking” on each screen portion 3, 4, 5, 6, 7, 8, and 9 activates the screens illustrated in the corresponding FIGS. 3 through 9.

In FIG. 3, UPC is used for part identification for those parts with a UPC. Parts without a UPC can be inventoried (or not) manually or with a manufacturer's or a locally assigned code and can be bar coded as desired. This is a mixed system just like the PTDA recommended system. As a manufacturer converts to the UPC the identification code for their products is changed accordingly.

Improved efficiency and accuracy can be achieved by using bar code readers to read the UPC bar codes already on most products. Instructions are provided at the IOL web site on the use of the bar code readers and for a basic system to log items into and out of the storeroom and to perform inventory audits.

A proposed primary control page is shown in FIG. 3. It is designed to allow users to easily review the status of their inventory. The page provides a form for the user to enter a UPC number 30 for a part. The system checks the number for authenticity with the check digit. The user then enters where used, a minimum part description 31, the vendor's code 32 (supplied by the vendor), the inventory source 33 (see below) and the minimum inventory level 34 desired. If the actual level falls to the minimum it will flag that item.

In the case of UPC coded parts, electronic monitoring of inventory levels of certain parts from certain vendors can be provided. Often a supply house will guarantee to inventory specific items for certain customers. All participating supply houses and manufacturers will, of course, have their inventory entered in the program. When an MIH identifies a supplier as the source of a minimum guaranteed inventory of a certain UPC, the level of inventory of that item held by that supplier appears on the control page as shown on FIG. 3. The level of inventory for each specified part is shown both for that day and for the minimum level held for the past year 36. This assures the MIH that the supply house is now stocking this item at or above the minimum level and has historically been doing so. IOL electronically polls the inventory of all participating suppliers and manufacturers at the end of each business day to maintain the database for this report.

To simplify identification each participating supply house, component manufacturer and MIH is provided with an ID number 32. The number identifies the state of its location, the company and the specific supply house, manufacturer or MIH within the state i.e. CA34526-3 identifies the #3 supply house outlet in California of company no. 34526. This identification system allows geographic constraint to the finally listed virtual inventory. For example, the virtual inventory can be constricted to a specific state, for example California. Sources for the inventory outside of the state do not appear in the inventory. Thus, the inventory is restricted in such a manner that only locally available parts are listed.

Supply houses may guarantee customers to stock certain items either at a specific outlet, within a specific state or somewhere within their entire organization. The numbering system allows the MIH to specify exactly what portion of a source to monitor.

Electronic monitoring of the inventory levels at all participating supply houses and manufacturers can occur. Neither the MIH nor his normal supplier needs to inventory a particular item if the MIH can depend on the general market for supply. If an MIH indicates on the control sheet the dependence upon the general market as the source of any particular item, the accumulated inventories of this item from all participating supply houses and the manufacturer appears on that MIH's control sheet as shown in FIGS. 1 and 3 under GMI 19 (see FIG. 1). The inventory for each specified part is shown for that day and for the minimum level held during the past year. The MIH can then see if this item is regularly available in the market at his comfort level. If so, it need not inventory the item.

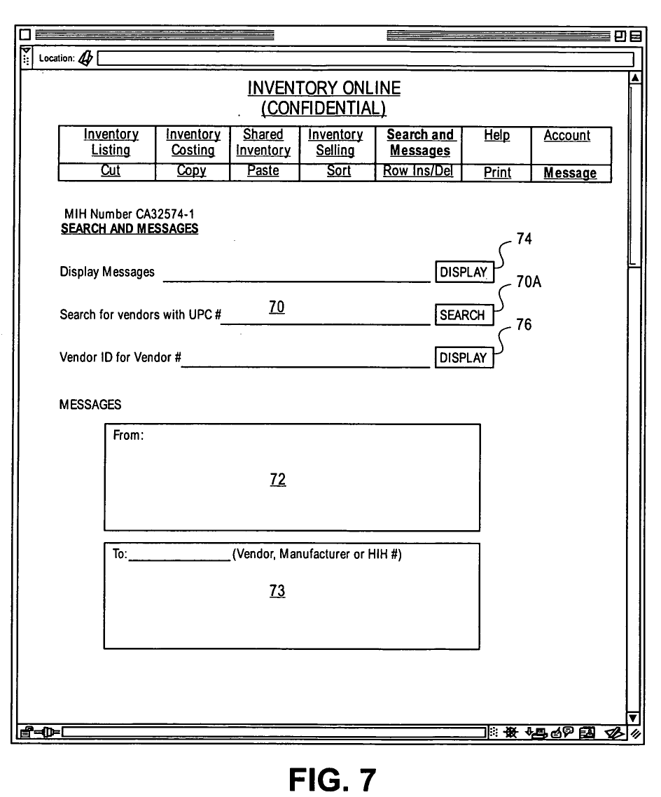

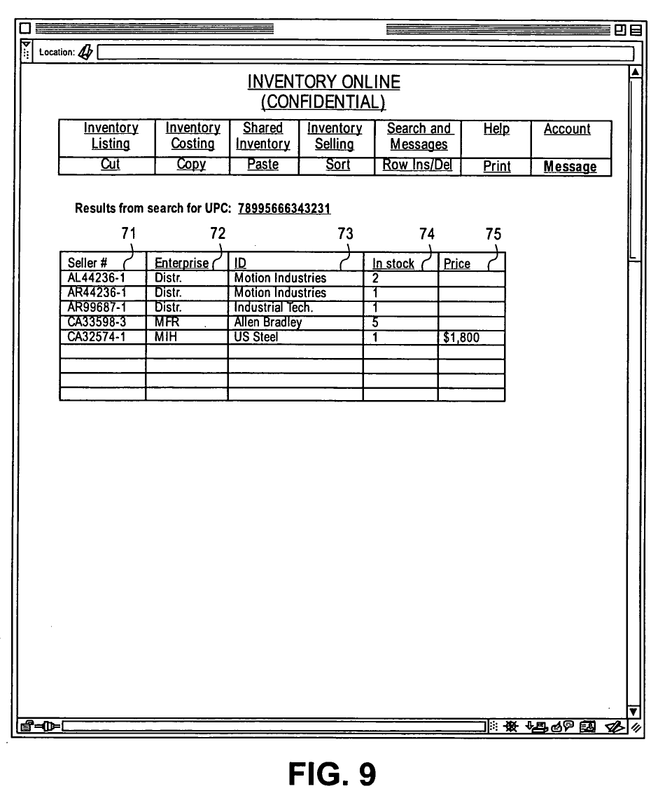

If it is required to purchase an item from this market, the MIH goes to the message and search page, as shown in FIG. 7, enters the UPC number 70 and prompts a search 70A for the ID of all sources of this UPC. A sample of the results from this search is shown in FIG. 9. Referring to FIG. 9, seller number 71, enterprise type 72, company named 73, the amount in stock 74, and price 75 are all displayed. A market inventory target level can also be set so the MIH can be warned if the market inventory falls below the comfort level. Next day delivery, if required, is assured through UPS, Federal Express or other carriers. Accurate tracking information on shipments is available on the Internet.

MIHs using this Market Inventory feature may want to purchase items from vendors with which they have no credit. The software can determine, keep current and make available the credit rating for any MIH requesting it and paying a nominal fee. Vendors may find that dealing with a national market enables them to keep a wider inventory of stock since they are selling to a far greater market than just their local one.

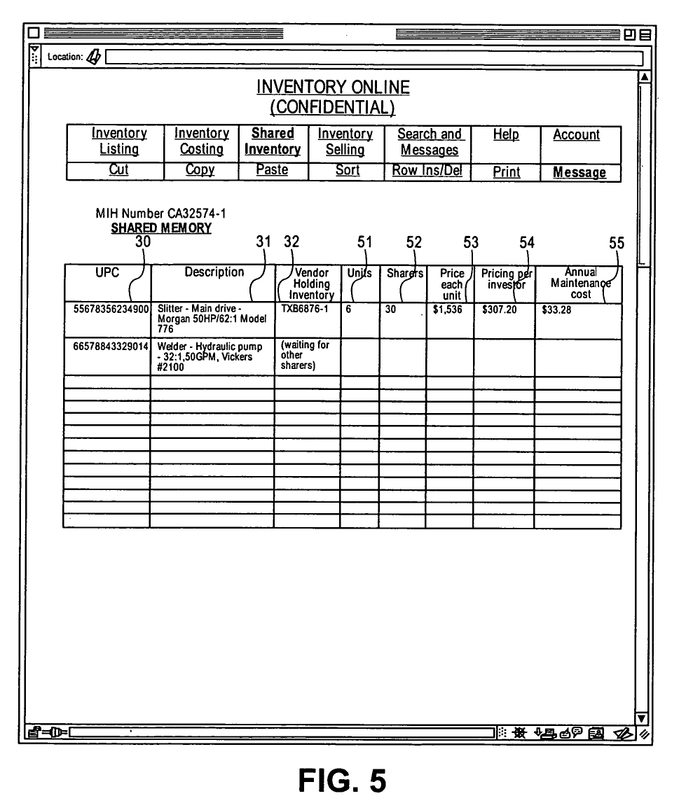

The software includes the capability to participate in Inventory Sharing with other MIHs. Items that MIHs want available that their regular vendor do not hold and are not readily or dependably available in the market can be included on an Inventory Sharing list (see FIG. 5). Items so identified can be held in a shared inventory with other users listing that same item. Referring to FIG. 5, UPC code 30, description 3 1, and vendor holding inventory or vendor ID 32 are shown. Units 51 available in total number of parties 52, unit Price 53, price per sharing party 54 as well as annual maintenance cost 55 are shown.

One has to believe that most replacement parts are held by more than just one MIH. Nearly all manufactured parts are produced in significant quantity and are surely held in many inventories. The shared inventory holds far fewer items than would be held if each MIH independently held their own. This will substantially reduce the initial purchase cost and the inventory maintenance cost. For example, if 25 subscribers from across the nation each listed one item with a eight week delivery time that each used in emergencies only, it is only be necessary to hold, conservatively, say five of these items. The subscriber saves 80% of the up-front cost of buying the item and only incurs 20% of the inventory maintenance charge. Of course, if an item were actually required the purchase cost is still incurred but only at the time it was needed and not at all if never needed. The maintenance cost would also be proportionately reduced.

The concept of Inventory Sharing savings can be readily illustrated. For example:
Inventory a $500 item independently:
Initial cost $500 plus tax and freight=$560
Annual maintenance @ 15%=$75
Share an inventory of five $500 items with 24 other users:
Initial cost $2,500 plus $300 freight=$112 per user.
Annual maintenance & profits to IOL @ 20% of the shared price=$20 per user.
An initial savings of $448 and an annual one of $55.

The number of items purchased for the number participants are set by IOL. Say two items for three participants, three for four to five, four for six to eight, etc. It would be progressively less expensive as more participants sign up. When at least three participants sign up, IOL would inform prospects of that condition and get their approval to initiate a shared inventory.

IOL makes the original purchase and charges participants pro rata for the purchase and monthly for the maintenance cost. The inventory is held by the manufacturer, his designated supply house or, lastly, by IOL. The inventory holder would receive the maintenance charges (and its profits) made to the MIHs. The status of the dedicated inventory appears on the participating MIH's Internet account as X number of items held for Y number of customers. (see FIG. 3).

When an item is needed the MIH informs the inventory holder, who ships it as instructed. The MIH then must replace that item selecting the vendor of his choice. This will probably be from his regular vendor of that part so that customer service could be expected.

Participating MIHs can drop out anytime. If they indicate they wish to drop out they continue to pay the inventory maintenance charge until someone orders that particular part to be sent or another participant signs up. They then get credit for their portion of the original purchase cost. If they just drop out they forfeit the purchase cost credit to the remaining participants. After one drops out the maintenance charges are adjusted for the remaining subscribers.

The reader will understand that inventories, per se, will never be communicated between maintenance inventory holders. However, items in inventory at one maintenance inventory holder can be communicated to other maintenance inventory holders, provided that the other maintenance inventory holder lists the particular item on his online inventory sharing list.

Regarding the listing of items in the inventory sharing list, three factors will be taken into consideration. These factors are the frequency with which replacement is needed, the impact that part failure will have on a manufacturing operation, and the replacement time that an item requires.

Parts that frequently fail will be maintained locally in inventory or required to be immediately obtainable from either a manufacturer or a supplier. Parts that fail at great interval will be sparse in inventory distribution. The listing maintenance inventory holder (MIH) will obviously take into account frequency of part failure.

Parts, which upon failure, have broad manufacturing impact will be maintained locally in inventory or required to be immediately obtainable, say from a supplier or component manufacturer. An example of such a part could be a steel cutting machine in a plant where the entire output of the plant would be suspended or curtailed until the cutting machine was returned to operation.

Finally, parts having long replacement times between order and parts delivery—say in the range of three months—will be required to be maintained in a shared inventory. For example, where the replacement of a steel cutting machine would require a three month time interval between order and receipt of a replacement steel cutting machine, this item would be a candidate for being listed in the inventory sharing list and physically placed where ready placement to the plant of the MIH could occur.

In the usual case, where multiple maintenance inventory holders designate the same part on the sharing list, and that part is not immediately available from a supplier and/or component manufacturer, it is preferred to have the part maintained at a neutral site. For example, by either partial or full payment, a group of (say three) maintenance inventory holders can each pay one third of the price of an inventory part having broad manufacturing impact and relatively long order lead time for replacement. The part could be maintained at a mutual supplier or in the manufacturer's inventory.

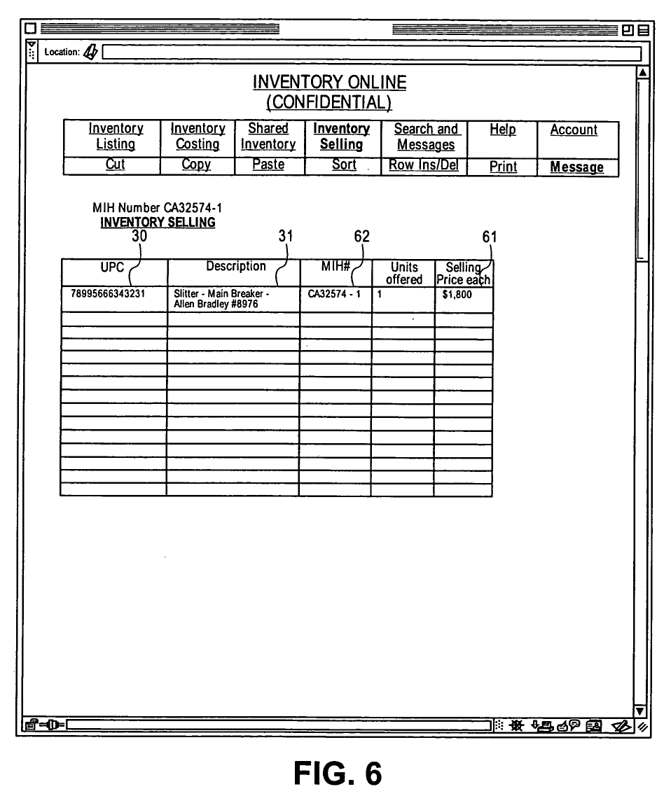

Referring to FIG. 6, the system includes the capability to sell dormant or excess inventory to other MIHs. MIHs wishing to sell unused dormant or unneeded inventory list the items by UPC 30 on their Inventory Selling sheet with the price 61 as shown in FIG. 6. These items are shown to be available from this MIH 62 upon a search for that UPC by another MIH as shown on the sample search results in FIG. 9.

Referring to FIG. 7, the system includes the capability to send and receive messages 72, 73 from manufacturers and supply houses on products they hold in inventory. Manufacturers are able to inform holders of a particular UPC manufactured by them of product upgrades, obsolescence or other pertinent technical information. A message could be sent to all holders of a certain UPC. A fee is charged manufacturers and supply houses for each message thereby gaining revenue and reducing advertising or other unnecessary communication. The MIH can also use the system to send and receive e-mail to and from suppliers. Message display is activated at 74 with in display area for vendor ID at 76.

Referring to FIG. 7, a “Message” panel shown on all control sheets will be lighted if a message to the MIH is waiting. This may be a message from a manufacturer, a vendor, another MIH inquiring about an item on Inventory Selling or from IOL about their account. The message can be retrieved on the Messages and Search page shown in FIG. 7.

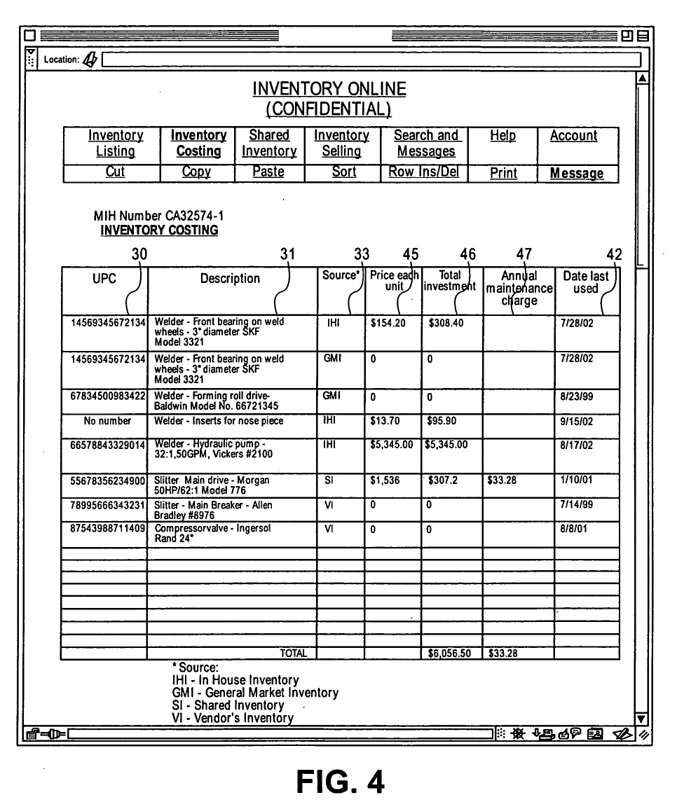

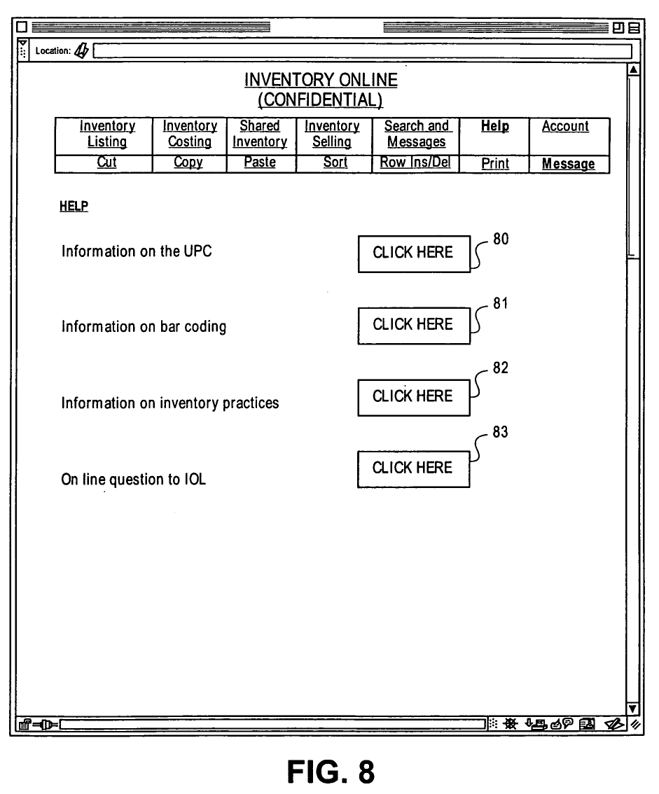

It can thus be seen that the software provides easy use of a program designed to supply basic pertinent information. In summary, the ASP inventory control web pages provide an “easy to read” accounting of maintenance inventory and sources (FIG. 3), the cost of that inventory (FIG. 4), the items “stocked” in Inventory Sharing (FIG. 5), the items for sale in Inventory Selling (FIG. 6), a Message and Search page (FIG. 7), and a Help page (FIG. 8). The software offers cut, copy, paste and sort functions to handle data and an access to one's account with IOL.

Referring to FIG. 4, it will be understood that the screen there shown is essentially a recasting of the information in FIG. 3 with the total investment in inventory being displayed at 40 together with annual maintenance charge 41. Dates last used 42 are displayed for convenience and determination of the proper number of inventory items. Price for each unit 45, total investment in unit 46 and annual maintenance charge for each unit 47 complete the discrete prices and costs needed to determine total inventory cost 40 and annual maintenance cost 41.

Referring to FIG. 8, a help screen is presented. Information on the UPC 80, information on barcode 81, information on inventory practices 82, and finally an online question 83 to the application service provider (ASP) 14 is provided.

It is highly desirable for supply houses to participate in this enterprise. They are central to the exchange of data. They already have a relationship with nearly all of the prospective customers and provide an effective agency through which to sell the IOL program. They also have many locations with attendants that are ideal to store shared inventory. They add legitimacy to the initial offering to MIHs. IOL would make it profitable for the supply houses to participate and to sign up MIHs. Supply houses should participate for the following reasons:

They get free use of the system. The software is designed with both the MIH and the supply house in mind. It is also designed to integrate with existing software in common use. They will be offered a percentage of the fees of MIHs that they sign up. For example, vendors will get 25% of the participation revenue from the MIHs they sign up. Their share of a $25/month participation by an MIH is worth over $500 in present value for a ten year participation. Customers and potential customers may rapidly and easily find if they hold specific items in inventory thereby improving sales and saving telephone time on inquiries. Further, upon a search for product initiated by an MIH they signed up, their company's locations appear first on the list. Finally, they and the manufacturers they represent can easily communicate with their customers electronically. Additionally, supply houses will get an opportunity to sell nationwide instead of just locally. This will be particularly attractive for smaller distributors.

Supply houses will get a profit from the maintenance charge to the MIH for the shared items they inventory. Further, it provides an opportunity to offer their customers a means to reduce their inventory costs. MIHs signed up by one supplier up will urge their other suppliers to also join. If supply houses do not participate they run the risk of losing business to competitors who do.

Manufacturers will be willing to participate. It allows for on line searches of their inventory providing convenience to their customers and saving telephone time for themselves. Further, the software system allows electronic communication about specific products to those customers holding that product. Only manufacturers that use the UPC for product identification will be using the electronic communication. This will be viewed as an advantage over non-bar coding competition. Also, if customers also use the same UPC for product identification it makes communication easier and more reliable. If they don't participate they run the risk of losing business to competitors who do.

MIHs will be willing to subscribe. They get the use of inventory control software. The cost is reasonable and a very small portion of a maintenance budget. It provides real time access to the inventory of all participating suppliers. This system uses the UPC requiring no set up time. One can start using it immediately and just incrementally add items until all, or as much of the inventory as desired, is under control. The UPC exactly identifies the product worldwide. There is no need for further identification or to keep a database relating the number to an exact part description. The manufacturer does this. Non-UPC parts can be inventoried (or not) without codes or with local or manufacturer's codes as desired.

The alternative of individually purchased software is fairly expensive and does not bring the same benefits. It is not connected to the Internet. Purchased software also becomes obsolete whereas the IOL software will be upgraded as technology improves. Information Technology service is provided by IOL, there is no license fee, the cost is known, the program is not customized so implementation time is short and on-line instruction and technical assistance would be available on the use of the system, on bar codes, bar code equipment and on better inventorying practices.

There is little risk. If an MIH does not like it they can get out after the initial commitment period.

The system enables MIHs to access suppliers or component manufacturers inventory electronically. It is to be noted that MIHs are not getting any information they couldn't get just by asking. Further, the system allows information on just the specific item of inquiry not a list of their whole inventory.

The supply houses with inventory control software can keep using their system. The systems can either be integrated or both systems can be used independently.

It will be understood that UPC is not used for all parts. This makes no difference. If it is desired those non-UPC parts can still be inventoried by the MIH. The e-commerce would be limited to the UPC items. But they constitute the major percentage of high-end maintenance parts right now and the number is growing all the time. The UPC is the international standard now for e-trade and will become a necessity for e-traded items in the near future. One has to believe that any manufacturer interested in promoting use of his products will do what's needed to participate. The IOL program should cause even more manufacturers to use the UPC.

Where MIHs want to search for a part but don't know the UPC number, it is usually on the package if they have one. If not, the manufacturers freely provide the number. Nearly all have web sites that could easily be set up to provide the UPC on the Internet once the demand is there.

1. An inventory online method to provide a virtually supplemented in-house inventory for the maintenance inventory holder to provide improved inventory control, reduce required on site inventory size, and reduce inventory cost comprising the steps of:
determining a maintenance inventory of parts for a manufacturer;
providing an online inventory listing of the maintenance inventory;
connecting the online inventory listing of the maintenance inventory to at least one other source selected from the group consisting of a vendor's inventory, a component manufacturer's inventory, a general market inventory, and a shared inventory from another maintenance inventory holder;
compiling the maintenance inventory for the manufacturer including the online inventory listing from the at least one other source to provide the virtually supplemented in-house inventory.

2. The inventory method according to claim 1 to provide a virtually supplemented in-house inventory for the maintenance inventory holder in including determining a maintenance inventory for the manufacturer by:
listing the maintenance inventory by UPC code.

3. The inventory online method according to claim 1 to provide a virtually supplemented in-house inventory for the maintenance inventory holder including:
connecting the online inventory listing of the maintenance inventory to a vendor's inventory of parts of the determined maintenance inventory of the manufacturer only.

4. The inventory online method according to claim 1 to provide a virtually supplemented in-house inventory for the maintenance inventory holder wherein they providing the online inventory listing of the maintenance inventory includes:
providing an online inventory program.

5. The inventory online method according to claim 4 to provide a virtually supplemented in-house inventory for the maintenance inventory holder includes:
providing an online inventory program from an application service provider.

6. The inventory online method according to claim 1 to provide a virtually supplemented in-house inventory for the maintenance inventory holder includes:
determining a plurality of maintenance inventory of parts for a plurality of manufacturers; and,
compiling the maintenance inventory for the plurality of manufacturers.

7. The inventory online method according to claim 6 to provide a virtually supplemented in-house inventory for the maintenance inventory holder wherein the compiling the maintenance inventory for a plurality of manufacturers further in includes:
listing items desired to be shared with other manufacturers and;
adjusting the compiled maintenance inventory for parts held in shared inventories

8. The inventory online method according to claim 7 to provide a virtually supplemented in-house inventory for the maintenance inventory includes:
adjusting the compiled maintenance inventory requirement for identical parts downward in the maintenance inventories for the plurality of manufacturers.

9. The inventory online method according to claim 1 to provide a virtually supplemented in-house inventory for the maintenance inventory holder includes:
searching inventories of vendors and component manufactures for desired items

10. The inventory online method according to claim 1 to provide a virtually supplemented in-house inventory for the maintenance inventory holder includes:
sending messages related to items the virtually supplemented in-house inventory.

11. The inventory online method according to claim 1 to provide a virtually supplemented in-house inventory for the maintenance inventory holder wherein the compiling step further in includes:
restricting compiling the maintenance inventory to at least one selected geographic location.

12. An inventory online system comprising:
a plurality of manufacturers each requiring a maintenance inventory;
an Internet connection to each of the plurality of manufacturers;
an online inventory program for listing the maintenance inventory of each of the plurality of manufacturers; and,
compiling the maintenance inventory for the plurality of manufacturers to provide a virtually supplemented in-house inventory with similar parts of each maintenance inventory virtually shared between the plurality of manufacturers whereby a similar part in one of the plurality of manufacturers is virtually counted to the maintenance inventory of another of the manufacturers without being duplicated in each maintenance inventory.

13. The inventory online system according to claim 11 and further comprising:
the online inventory program for listing the maintenance inventory of each of the plurality of manufacturers lists the maintenance inventory by UPC code.

14. The inventory online system according to claim 11 and further comprising:
compiling the maintenance inventory for the plurality of manufacturers by listing a similar part at one manufacturer on the virtual inventory of another manufacture without having the similar part physically present at both manufacturers.

15. The inventory online system according to claim 11 and further comprising:
sending messages between the plurality of manufacturers related to specific items in inventory.
